(19) United States
(12) Patent Application Publication
(10) Pub. No.: US 2021/0241080 A1
(43) Pub. Date: Aug. 5, 2021

(54) ARTIFICIAL INTELLIGENCE ACCELERATOR AND OPERATION THEREOF

(71) Applicant: MACRONIX International Co., Ltd., Hsinchu (TW)

(72) Inventors: HANG-TING LUE, Hsinchu (TW); Teng-Hao Yeh, Hsinchu County (TW); Po-Kai Hsu, Tainan City (TW); Ming-Liang Wei, Kaohsiung City (TW)

(73) Assignee: MACRONIX International Co., Ltd., Hsinchu (TW)

(21) Appl. No.: 16/782,972

(22) Filed: Feb. 5, 2020

(51) Int. Cl. G06N 3/063; G06F 7/50; G06F 5/01; G06F 9/50

(52) U.S. Cl. CPC G06N 3/063; G06F 9/5027; G06F 5/01; G06F 7/50

(57) ABSTRACT

An artificial intelligence accelerator receives a binary input data set and a selected layer of layers of overall weight pattern. The artificial intelligence accelerator includes processing tiles and a summation output circuit. Each processing tile receives one of input data subsets of the input data set and performs a convolution operation on weight blocks of each sub weight pattern of the overall weight pattern to obtain weight operation values and then obtains a weight output value expected from a direct convolution operation on the input data subset with the sub weight pattern through performing a multistage shifting and adding operation on the weight operation values. The summation output circuit sums up the plurality of weight output values through a multistage shifting and adding operation, so as to obtain a sum value expected from a direct convolution operation performed on the input data set with the overall weight pattern.

### BACKGROUND OF THE INVENTION

### 1. Field of the Invention

The invention relates to the technologies of artificial intelligence accelerators, and more specifically, to an artificial intelligence accelerator that includes split input bits and split weight blocks.

### 2. Description of Related Art

Applications of an artificial intelligence accelerator include, for example, functioning as something like a filter to identify a matching degree between a pattern represented by input data and a known pattern. For example, one of the applications is that the artificial intelligence accelerator identifies whether a photographed image includes an eye, a nose, a face, or other information.

Data to be processed by the artificial intelligence accelerator is, for example, data of all pixels of an image. To be specific, its input data is data that includes a large number of bits. After the data is input in parallel, a comparative operation is performed on various patterns stored in the artificial intelligence accelerator. The patterns are stored in a large number of memory cells in a weighted manner. An architecture of the memory cells is a 3D architecture, and includes a plurality of 2D memory cell layers. Each layer represents a characteristic pattern, and is stored in a memory cell array layer in a weighted value manner. A memory cell array layer to be processed is opened sequentially as controlled by a character line. The data is input by a bit line. A convolution operation is performed on the input data and a memory cell array to obtain a matching degree of a characteristic pattern corresponding to this memory cell array layer.

The artificial intelligence accelerator needs to handle a large amount of computation. If a plurality of memory cell array layers is integrated in one unit and are processed on a per-bit basis, an overall circuit thereof will be very large. In this way, an operation speed is lower and more energy is consumed. Considering that the artificial intelligence accelerator requires a high speed of processing for filtering and recognizing content of an input image, an operation speed, for example, generally needs to be further improved in designing a single-circuit chip.

### SUMMARY OF THE INVENTION

Embodiments of the invention provide an artificial intelligence accelerator. The artificial intelligence accelerator includes split input bits and split weight blocks. Through a shifting and adding operation, parallel operated values are combined to restore an expected operation result of a single chip, thereby effectively improving a processing speed of the artificial intelligence accelerator and reducing power consumption.

In an embodiment, the invention provides an artificial intelligence accelerator, configured to receive a binary input data set and a selected layer of a plurality of layers of an overall weight pattern to perform a convolution operation. The input data set is divided into a plurality of data subsets. The artificial intelligence accelerator includes a plurality of processing tiles and a summation output circuit. Each of the processing tiles includes a receive-end component, configured to receive one of the data subsets. The weight storage unit is configured to store a part of the overall weight pattern, where the partial weight storage unit includes a plurality of weight blocks, and each of the weight blocks stores a block part of the partial weight pattern in order of bits, wherein a cell array structure of the weight storage unit, with respect to a corresponding one of the data sets, configured to perform a convolution operation on the data subset with each block part respectively to obtain a plurality of sequential weight operation values. The block-wise output circuit includes a plurality of shifters and a plurality of adders, and is configured to sum up the plurality of weight operation values through a multistage shifting and adding operation, so as to obtain a weight output value expected from a direct convolution operation performed on the data subset with the partial weight pattern. The summation output circuit includes a plurality of shifters and a plurality of adders, and is configured to sum up the plurality of weight output values through a multistage shifting and adding operation, so as to obtain a sum value expected from a direct convolution operation performed on the input data set with the overall weight pattern.

In an embodiment, for the artificial intelligence accelerator, the input data set includes i bits, and is divided into p data subsets, i and p are integers, and each of the data subsets includes i/p bits.

In an embodiment, for the artificial intelligence accelerator, the input data set includes i bits, and the quantity of the plurality of processing tiles is p, the input data set is divided into p data subsets, i and p are integers greater than or equal to 2, i is greater than p, and each of the data subsets includes i/p bits.

In an embodiment, for the artificial intelligence accelerator, the quantity of the plurality of weight blocks included in the partial weight storage unit is q, q is an integer greater than or equal to 2, the partial weight storage unit includes j bits, j and q are integers greater than or equal to 2, j is greater than q, and each of the weight blocks includes j/q memory cells.

In an embodiment, for the artificial intelligence accelerator, the block-wise output circuit includes at least one shifter and at least one adder in each stage of the shifting and adding operation. Two adjacent input values of a plurality of input values in each stage are one processing unit, after passing through the shifter, one input value in a higher bit location is added by the adder to the other input value in a lower bit location, and is output to a next stage, and in a last stage, a single value is output and used as the weight output value corresponding to the processing tile.

In an embodiment, for the artificial intelligence accelerator, a shift amount of the shifter in a first stage is j/q memory cells, and a shift amount of the shifter in a next stage is twice that of the shifter in a previous stage.

In an embodiment, for the artificial intelligence accelerator, the summation output circuit includes at least one shifter and at least one adder in each stage of the shifting and adding operation. Two adjacent input values of a plurality of input values in each stage are one processing unit, after passing through the shifter, one input value in a higher bit location is added by the adder to the other input value in a lower bit location, and is output to a next stage, and in a last stage, a single value is output and used as the sum value.

In an embodiment, for the artificial intelligence accelerator, a shift amount of the shifter in a first stage is i/p bits, and a shift amount of the shifter in a next stage is twice that of the shifter in a previous stage.

In an embodiment, the artificial intelligence accelerator further includes: a normalization processing circuit, configured to normalize the sum value to obtain a normalization sum value; and a quantization processing circuit, configured to quantize the normalization sum value into an integer value by using a base number.

In an embodiment, for the artificial intelligence accelerator, the processing circuit includes a plurality of sense amplifiers, respectively configured to sense each block part to perform a convolution operation to obtain a plurality of sensed values as the plurality of weight operation values.

In an embodiment, the invention further provides a processing method applied to an artificial intelligence accelerator. The artificial intelligence accelerator receives a binary input data set and a selected layer of a plurality of layers of an overall weight pattern to perform a convolution operation, where the input data set is divided into a plurality of data subsets. The processing method includes: using a plurality of processing tiles, where each of the processing tiles includes operations of: using a receive-end component to receive one of the data subsets; using a weight storage unit to store a part of the overall weight pattern, where the partial weight storage unit includes a plurality of weight blocks, and each of the weight blocks stores a block part of the partial weight pattern in order of bits, wherein a cell array structure of the weight storage unit, with respect to a corresponding one of the data sets, is configured to perform a convolution operation on the data subset with each block part respectively to obtain a plurality of sequential weight operation values; using a block-wise output circuit that includes a plurality of shifters and a plurality of adders to sum up the plurality of weight operation values through a multistage shifting and adding operation, so as to obtain a weight output value expected from a direct convolution operation performed on the data subset with the partial weight pattern; and using a summation output circuit that includes a plurality of shifters and a plurality of adders to sum up the plurality of weight output values through a multistage shifting and adding operation, so as to obtain a sum value expected from a direct convolution operation performed on the input data set with the overall weight pattern.

In an embodiment, for the processing method of the artificial intelligence accelerator, the input data set includes i bits, and is divided into p data subsets, i and p are integers, and each of the data subsets includes i/p bits.

In an embodiment, for the processing method of the artificial intelligence accelerator, the input data set includes i bits, and the quantity of the plurality of processing tiles is p, the input data set is divided into p data subsets, i and p are integers greater than or equal to 2, i is greater than p, and each of the data subsets includes i/p bits.

In an embodiment, for the processing method of the artificial intelligence accelerator, the quantity of the plurality of weight blocks included in the partial weight storage unit is q, q is an integer greater than or equal to 2, the partial weight storage unit includes j bits, j and q are integers greater than or equal to 2, j is greater than q, and each of the weight blocks includes j/q memory cells.

In an embodiment, for the processing method of the artificial intelligence accelerator, an operation of the block-wise output circuit includes using at least one shifter and at least one adder in each stage of the shifting and adding operation. Two adjacent input values of a plurality of input values in each stage are one processing unit, after passing through the shifter, one input value in a higher bit location is added by the adder to the other input value in a lower bit location, and is output to a next stage, and in a last stage, a single value is output and used as the weight output value corresponding to the processing tile.

In an embodiment, for the processing method of the artificial intelligence accelerator, a shift amount of the shifter in a first stage is j/q memory cells, and a shift amount of the shifter in a next stage is twice that of the shifter in a previous stage.

In an embodiment, for the processing method of the artificial intelligence accelerator, an operation of the summation output circuit includes using at least one shifter and at least one adder in each stage of the shifting and adding operation. Two adjacent input values of a plurality of input values in each stage are one processing unit, after passing through the shifter, one input value in a higher bit location is added by the adder to the other input value in a lower bit location, and is output to a next stage, and in a last stage, a single value is output and used as the sum value.

In an embodiment, for the processing method of the artificial intelligence accelerator, a shift amount of the shifter in a first stage is i/p bits, and a shift amount of the shifter in a next stage is twice that of the shifter in a previous stage.

In an embodiment, the processing method of the artificial intelligence accelerator further includes: using a normalized processing circuit to normalize the sum value to obtain a normalization sum value; and using a quantization processing circuit to quantize the normalization sum value into an integer value by using a base number.

In an embodiment, for the processing method of the artificial intelligence accelerator, the processing circuit includes a plurality of sense amplifiers, respectively configured to sense each block part to perform a convolution operation to obtain a plurality of sensed values as the plurality of weight operation values.

To make the features and advantages of the invention clear and easy to understand, the following gives a detailed description of embodiments with reference to accompanying drawings.

### BRIEF DESCRIPTION OF THE DRAWINGS

FIG. 1 is a schematic diagram of a basic architecture of an artificial intelligence accelerator according to an embodiment of the invention.

FIG. 2 is a schematic diagram of an operating mechanism of an artificial intelligence accelerator according to an embodiment of the invention.

FIG. 3 is a schematic planning diagram of an artificial intelligence accelerator according to an embodiment of the invention.

FIG. 4 is a schematic planning diagram of an artificial intelligence accelerator according to an embodiment of the invention.

FIG. 5 is a schematic architecture diagram of a memory cell of a memory unit according to an embodiment of the invention.

FIG. 6 is a schematic mechanism diagram of summation performed by a processing tile for a plurality of weight blocks according to an embodiment of the invention.

FIG. 7 is a schematic diagram of a summing circuit between a plurality of processing tiles according to an embodiment of the invention.

FIG. 8 is a schematic diagram of overall application configuration of an artificial intelligence accelerator according to an embodiment of the invention.

FIG. 9 is a schematic flowchart of a processing method of an artificial intelligence accelerator according to an embodiment of the invention.

### DESCRIPTION OF THE EMBODIMENTS

Embodiments of the invention provide an artificial intelligence accelerator that includes split input bits and split weight blocks. With the split input bits being parallel to the split weight blocks, parallel operated values are combined through a shifting and adding operation to restore an expected operation result of a single chip, thereby effectively improving a processing speed of the artificial intelligence accelerator and reducing power consumption.

Several embodiments are provided below to describe the invention, but the invention is not limited to the embodiments.

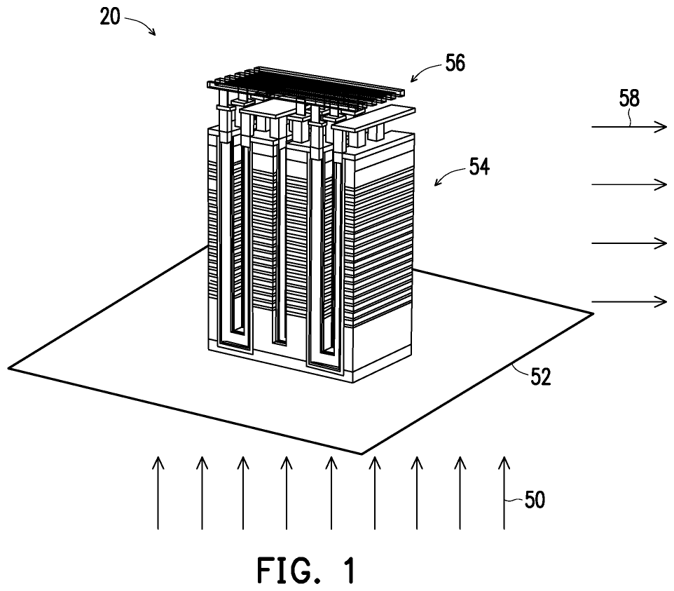

FIG. 1 is a schematic diagram of a basic architecture of an artificial intelligence accelerator according to an embodiment of the invention. Referring to FIG. 1, an artificial intelligence accelerator 20 includes a NAND memory unit 54 configured in a 3D structure. The NAND memory unit includes a plurality of 2D memory array layers. Each memory cell of each memory array layer stores a weight value. All weight values of each memory array layer constitute a weight pattern based on preset features. For example, the weight patterns are data of a pattern to be recognized, such as data of a shape of a face, an ear, an eye, a nose, a mouth, or an object. Each weight pattern is stored as a 2D memory array in a layer of a 3D NAND memory unit 54.

Through a cell array structure 56 with respect to the input data of the artificial intelligence accelerator 20 by a routing arrangement, a weight pattern stored in a memory cell may be subjected to a convolution operation performed together with input data 50 received and converted by a receive-end component 52. For example, the convolution operation is generally a multiplication operation on a matrix to obtain an output value. Output data 58 is obtained by performing a convolution operation on a weight pattern layer through the cell array structure 56. The convolution operation may be based on the usual way in the art without specifically limitation. The operation in detail is not further described in the embodiments. The output data 58 may represent a matching degree between the input data 50 and the weight pattern. In terms of performance, each weight pattern layer is similar to a filtering layer of an object and implements a recognition function by recognizing the matching degree between the input data 50 and the weight pattern.

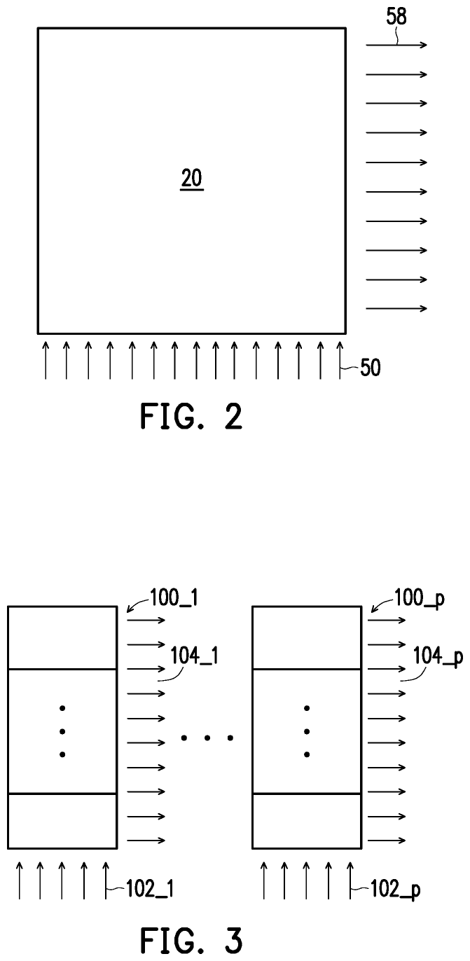

FIG. 2 is a schematic diagram of an operating mechanism of an artificial intelligence accelerator according to an embodiment of the invention. Referring to FIG. 1 and FIG. 2, the input data 50 is, for example, digital data of an image. For example, for a dynamically detected image, the artificial intelligence accelerator 20 recognizes whether a part or all of an actual image photographed by a camera at any time includes at least one of a plurality of objects stored in the memory unit 54. Due to a higher resolution of the image, a datagram of an image includes a large amount of data. The architecture of the memory unit 54 is a 3D structure that includes a plurality of 2D memory cell array layers. A memory cell array layer includes i bit lines configured to input data and j selection lines corresponding to a weight row. To be specific, the memory unit 54 configured to store a weight is constituted by multi-layer i*j matrices. Parameters i and j are large integers. The input data 50 is received by the bit lines of the memory unit 54. The bit lines receive pixel data of the image respectively. Through a peripherally configured processing circuit, a convolution operation that includes matrix multiplication is performed on the input data 50 and the weight to output operated data 58.

A direct convolution operation may be performed by using a single bit and a single weight one by one. However, because the amount of data to be processed is very large, an overall memory unit is very large and constitutes a considerably large processing chip. The speed of operation may be relatively slow. In addition, power (heat) consumption generated by operation of a large-sized chip is also relatively large. Expected functions of the artificial intelligence accelerator require a relatively high recognition speed and lower power consumption of operation.

FIG. 3 is a schematic planning diagram of an artificial intelligence accelerator according to an embodiment of the invention. Referring to FIG. 3, the invention further provides an operation planning manner of an artificial intelligence accelerator. The artificial intelligence accelerator in the invention keeps receiving overall input data 50 that is input in parallel, but divides the input data 50 (also referred to as an input data set) into a plurality of input data subsets 102_1, . . . , 102_p. Each of the input data subsets 102_1, . . . , 102_p is respectively subjected to a convolution operation performed by one of the processing tiles 100_1, . . . , 100_p. Each of the processing tiles 100_1, . . . , 100_p processes only a part of an overall convolution operation. For example, the input data 50 includes i bit lines. The i bit lines are divided into p sets, where p is 2 or an integer greater than 2. In this way, a processing tile includes i/p bit lines configured to receive the input data subsets 102_1, . . . , 102_p. To be specific, an input data subset is data that includes i/p bits. Herein, a relationship between the parameters i and p is that i is divisible by p. However, if i bit lines are not divisible by p processing tiles, then a last one of the processing tiles processes only remaining bit lines. This may be planned according to actual needs without limitation.

According to the architecture in FIG. 3, a currently open weight pattern layer is processed by p processing tiles 100_1, . . . , 100_p to perform a convolution operation. Corresponding to p processing tiles, overall input data is also divided into p input data subsets 102_1, . . . , and 102_p and input to the corresponding processing tiles 100_1, . . . , 100_p. Output values obtained from the convolution operation performed by the p processing tiles 100_1, . . . , 100_p are 104_1, . . . , 104_p, which may be electric current values, for example. Thereafter, by performing a shifting and adding operation to be described later, a result of the convolution operation performed on the overall input data set and the overall weight pattern may be obtained.

With respect to a splitting manner in FIG. 3, a partial weight pattern stored in the processing tiles is directly subjected to a convolution operation with the input data subsets. Efficiency of the convolution operation may be further improved. In an embodiment, the invention further provides block planning for weights.

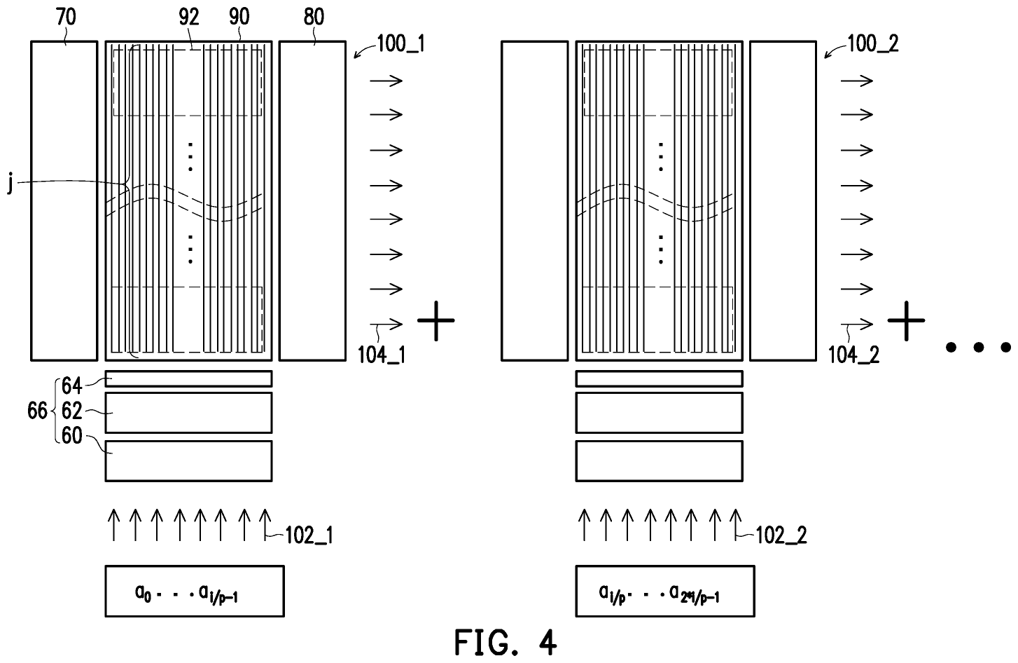

FIG. 4 is a schematic planning diagram of an artificial intelligence accelerator according to an embodiment of the invention. Referring to FIG. 4, an overall preset input data set includes, for example, i pieces of data that rank from 0 to i−1. Examples of the i pieces of data are binary values a₀, . . . , aᵢ₋₁, where each bit a is considered as input data of a bit line. In this way, the data is input by i bit lines. In an embodiment, for example, the i pieces of data are divided into p sets, that is, input data subsets 102_1, 102_2, . . . . Each of the input data subsets 102_1, 102_2, . . . includes, for example, i/p pieces of data, but a plurality of processing tiles 100_1, 100_2, . . . is sequentially configured. The processing tiles 100_1, 100_2, . . . each receive a corresponding one of the input data subsets 102_1, 102_2, . . . in corresponding order of the overall input data set. For example, the first processing tile receives data from a₀ to a_{i/p-1}, a next processing tile receives data from a_{i/p} to a_{2*i/p-1}, and so on. The input data subsets 102_1, 102_2 . . . are received by a receive-end component 66. The receive-end component 66 includes, for example, a sense amplifier 60 to sense digital input data. A bit line decoder circuit 62 obtains a corresponding logic output, and a voltage switch 64 inputs data. The receive-end component 66 is set according to actual needs, and the invention does not limit circuit configuration of the receive-end component 66.

Each of the input data subsets 102_1, 102_2, . . . is subjected to a convolution operation performed by a corresponding one of the processing tiles 100_1, 100_2, . . . . The convolution operation of the processing tiles 100_1, 100_2, . . . is a part of the overall convolution operation. Each of the input data subsets 102_1, 102_2, . . . received by each corresponding processing tile 100_1, 100_2, . . . is processed respectively in parallel. Through the receive-end component 66, the input data subsets 102_1, 102_2, . . . enter memory cells associated with a memory unit 90.

In an embodiment, the quantity of memory cells storing weight values in a row is, for example, j, where j is a large integer. That is to say, there are j memory cells corresponding to one bit line. Each memory cell stores a weight value. Herein, a memory cell row may also be referred to as a selection line. In an embodiment, j memory cells may be split into, for example, q weight blocks 92. In an embodiment where j is divisible by q, one weight block includes j/q memory cells. From an output-side perspective, a memory cell is also a bit equivalent to a binary string. In order of weights, q weight blocks 92 ranging from 0 to j−1 are generated out of splitting.

From the overall convolution operation, a sum value needs to be obtained. The sum value is denoted by Sum, as shown in a formula (1):

Sum=Σa*W (1)

where “a” represents an input data set, and W represents a two-dimensional array of a selected layer of weight in the memory unit.

For the input data set that is input, if the input data set includes data of eight bits, for example, the input data set is denoted by a binary string [a₀a₁ . . . a₇]. The binary string is, for example, [10011010], and corresponds to a decimal value. Similarly, a weight block is also denoted by a bit string. For example, the first weight block includes [W₀ . . . W_{j/q-1}]. Sequentially, the last weight block is denoted by [W_{(q-1)*j/q} . . . Wⱼ₋₁]. Each weight block also represents a decimal value.

In this way, the overall convolution operation is denoted by a formula (2):

SUM=(W₀ . . . W_{j/q-1}*2⁰+ . . . +W_{(q-1)*j/q} . . . Wⱼ₋₁*2^{j*(q-1)/q})*2⁰*a₀ . . . a_{i/p-1}+(W₀ . . . W_{j/q-1}*2⁰+ . . . +W_{(q-1)*j/q} . . . Wⱼ₋₁*2^{j*(q-1)/q})*2^{i/p}*a_{i/p} . . . a_{2*i/p-1}+ . . . +(W₀ . . . W_{j/q-1}*2⁰+ . . . +W_{(q-1)*j/q} . . . Wⱼ₋₁*2^{j*(q-1)/q})*2^{i*(p-1)/p}*a_{(p-1)*i/p} . . . aᵢ₋₁ (2)

For a weight pattern stored in a two-dimensional array of i*j shown in FIG. 2, Sum is a value expected from a convolution operation performed on the weight pattern with the overall input data set (a₀ . . . aᵢ₋₁). The convolution operation is integrated in the configuration of the cell array structure, so that the input data in multiple bits through the routing manner is subjected to convolution operation with the weight pattern as stored in the memory cells of the selected layer. Details of practical convolution operation of a matrix are disclosed in the prior art, and are omitted herein. In the embodiment of the invention, through the convolution operation, the weight data is split and operated in parallel by a plurality of processing tiles 100_1, 100_2, . . . . A plurality of weight blocks 92 into which each of the processing tile 100_1, 100_2, . . . is split may also be operated in parallel. In an embodiment of the invention, for each processing tile, the plurality of weight blocks generated from splitting is restored to a desired result of a single overall weight block by means of shifting and adding. In addition, by means of shifting and adding, the split a plurality of processing tiles may be summed up to obtain a desired overall operation value.

A processing circuit 70 is also disposed for each of the processing tiles 100_1, 100_2, . . . to perform a convolution operation. In addition, a block-wise output circuit 80 is also disposed for the processing tiles 100_1, 100_2, . . . and includes a multistage shifting and adding operation. For parallel zero-stage output data, corresponding data such as [W₀ . . . W_{j/q-1}], . . . is obtained in order of bits (memory cells). A final overall convolution operation result is obtained also by performing a shifting and adding operation between the processing tiles.

In this configuration above, the operation on one weight block in one processing tile needs a storage amount of 2^{(i/p+j/q)}. To the whole operation, it includes p processing tiles and each processing tile includes q weight blocks. The total storage amount as needed may be reduced to p*q*2^{(i/p+j/q)}.

The following describes in detail how to obtain an overall operation result based on split weight blocks and split processing tiles.

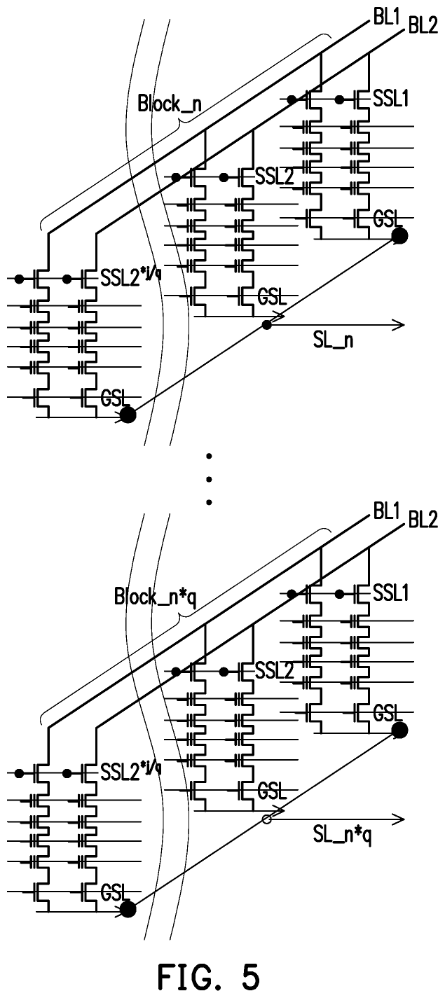

FIG. 5 is a schematic architecture diagram of a memory cell of a memory unit according to an embodiment of the invention. Referring to FIG. 5, a processing tile memory unit includes a plurality of memory cell strings corresponding to each of bit lines BL_−1, BL_2, . . . , which are vertically connected to a bit line (BL) to form a 3D structure. Each memory cell of the memory cell string belongs to one memory cell array layer, and stores one weight value of weight patterns. A memory cell string on the bit lines BL_−1, BL_2, . . . is started by a selection line (SSL). Memory cells corresponding to a plurality of selection lines (SSLs) constitute a weight block, denoted by Block_n. Input data is input by the bit line (BL), and flows into a corresponding memory cell under control to undergo a convolution operation. Thereafter, the data is combined and output by an output end SL_n. The memory unit includes q blocks, denoted by Block_n*q.

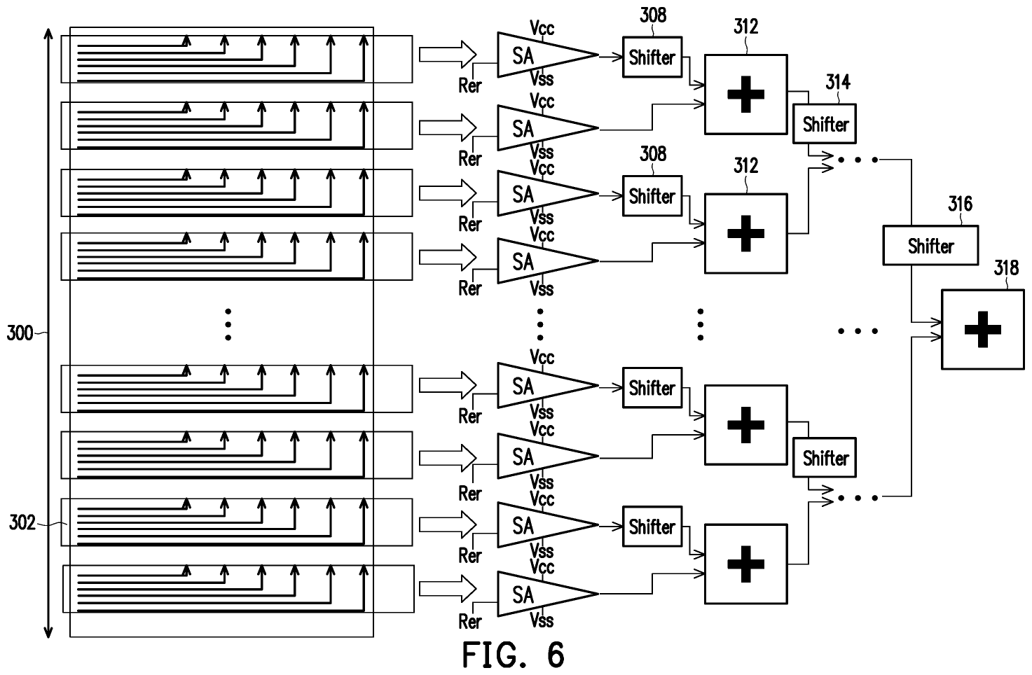

FIG. 6 is a schematic mechanism diagram of summation performed by a processing tile for a plurality of weight blocks according to an embodiment of the invention. Referring to FIG. 6, a memory unit 300 of a processing tile is split into a plurality of weight blocks 302. Each weight block 302 is subjected to a convolution operation with an input data subset, and an operation value of each weight block 302 is output in parallel, as indicated by a thick arrow. Thereafter, as sensed by a sense amplifier (SA), a sense signal such as an electrical current value is output. Because weights are arranged in binary and output in parallel, to obtain a decimal value, an embodiment of the invention provides a configuration of a block-wise output circuit, where two adjacent output values are added by an adder 312. In the two output values, an output value in a higher bit location is shifted to a corresponding location first by a shifter 308 that can shift a value by a preset number of digital bits. For example, a weight block includes j/q bits (memory cells). An output value in a higher bit location needs to be shifted to a higher location by j/q bits. Therefore, a shifter 308 in a first stage of shifting and adding operation enables shifting by j/q bits. After the addition by the first-stage adder, the output value represents a value of 2*j/q bits. Thereafter, a mechanism of a second stage of shifting and adding operation is the same, but a shift amount of a shifter 314 is 2*j/q bits. By analogy, in a last stage, only two input values exist, and only one shifter 316 is needed, but a shift amount is, for example, 2^{(log}^{₂}^{q-1)}*j/q bits, whereby a convolution operation result of a processing tile is obtained.

It should be noted that weight blocks of one weight pattern layer may also be distributed onto a plurality of different processing tiles based on planning and combination of the weight blocks. To be specific, weight blocks stored in one processing tile do not require the same layer of weight data. On the other hand, weight blocks of one weight data layer are distributed to a plurality of processing tiles. Therefore, the processing tiles may be operated in parallel. That is, each of the plurality of processing tiles performs operations for only block layers to be processed, and then combines operation data of the same layer.

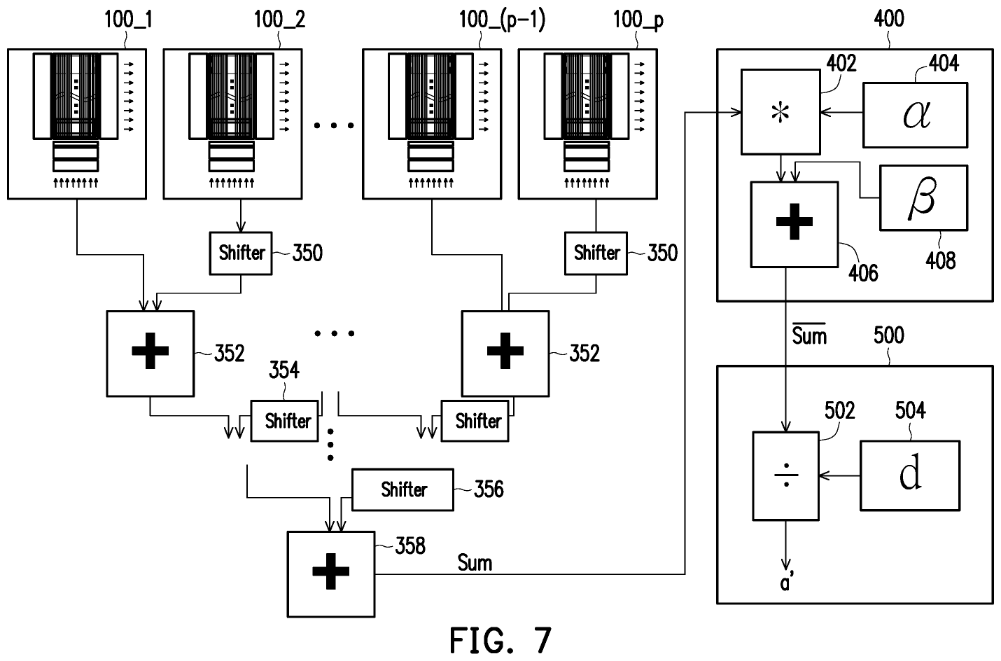

The following describes a shifting and adding operation in which a plurality of processing tiles is integrated. FIG. 7 is a schematic diagram of an operation mechanism of a summing circuit between a plurality of processing tiles according to an embodiment of the invention. Referring to FIG. 7, p processing tiles 100_1, 100_2, . . . , 100_p perform shifting and adding operations based on the output values in FIG. 6 respectively. Each of the processing tiles 100_1, 100_2, . . . , 100_p herein corresponds to a convolution operation result of an input data subset in the same weight pattern layer.

Similar to the scenario in FIG. 6, an input data set is a binary input string, but is i/p bits, for example, for each input data subset. Therefore, the first stage of shifting and adding operation is also to use an adder 352 to add each pair of adjacent output values, where a value in a higher bit location is shifted by a shifter 350 by i/p bits first. The shifter 354 of a next stage of shifting and adding operation shifts a value by 2*i/p bits. A shift amount of a last-stage shifter 356 is 2^{(log}^{₂}^{p-1)}*i/p bits. A sum value (Sum) shown in the formula (1) may be obtained after the last stage of shifting and adding operation.

The sum value (Sum) at this stage is a preliminary value. In practical applications, the sum value needs to be normalized. For example, a normalization circuit 400 normalizes the sum value to obtain a normalization sum value. The normalization circuit includes, for example, an operation of a formula (3):

S̅u̅m̅=α*Sum+β (3)

where a constant α 404 is a scaling value, and adjusts the sum value (Sum) through a multiplier 402 first, and then adjusts an offset β 408 through the adder 406.

The normalization sum value is processed by a quantization circuit 500, where the sum value is quantized by a divider 502 by dividing a base number d 504, as shown in a formula (4):

$${a}^{′} = [ {\frac{Sum}{d}}^{\overline{ }} + 0.5 ] \qquad ( 5 )$$

where 0.5 represents a rounding-off operation. Generally, the more the input data set matches a characteristic pattern of this layer, the larger the quantization value a′ thereof will be.

After completion of the convolution operation for one weight pattern layer, a convolution operation for a next weight pattern layer is selected by using a word line.

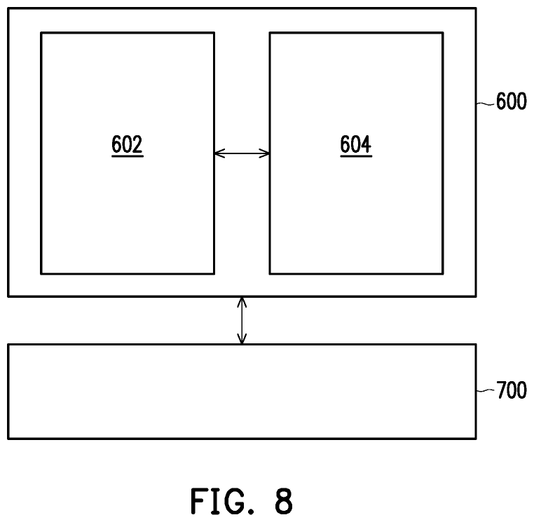

FIG. 8 is a schematic diagram of overall application configuration of an artificial intelligence accelerator according to an embodiment of the invention. Referring to FIG. 8, an artificial intelligence accelerator 602 of an overall system 600 may communicate bidirectionally with a control unit 604 of a host. For example, the control unit 604 of the host obtains input data such as digital data of an image from an external memory 700. The data is input into the artificial intelligence accelerator 602, where a characteristic pattern of the data is recognized and a result is returned to the control unit 604 of the host. Application of the overall system 600 may be configured as actually required, and is not limited to the configuration manner enumerated herein.

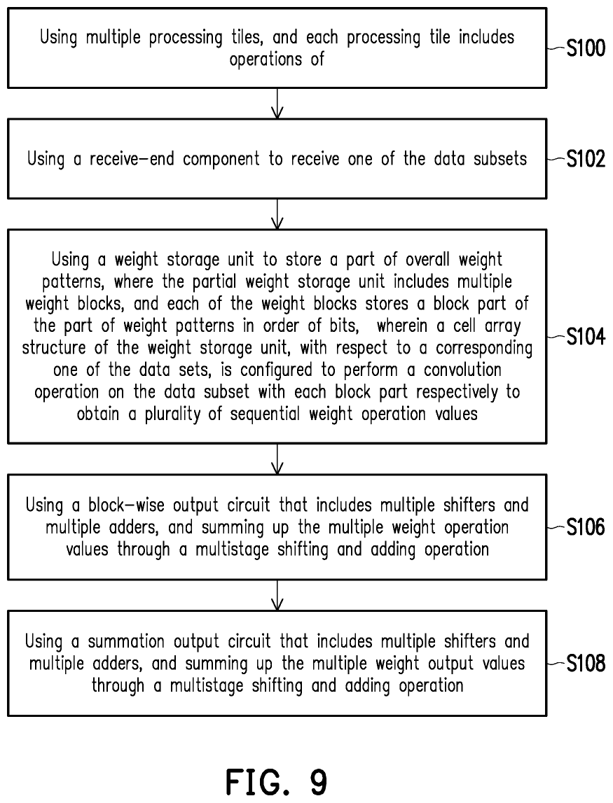

An embodiment of the invention further provides a processing method of an artificial intelligence accelerator. FIG. 9 is a schematic flowchart of a processing method of an artificial intelligence accelerator according to an embodiment of the invention.

Referring to FIG. 9, an embodiment of the invention further provides a processing method applied to an artificial intelligence accelerator. The artificial intelligence accelerator receives a binary input data set and a selected layer of a plurality of layers of an overall weight pattern to perform a convolution operation, where the input data set is divided into a plurality of data subsets. The processing method includes step S100: using a plurality of processing tiles, where each of the processing tiles includes: step S102: using a receive-end component to receive one of the data subsets; step S104: using a weight storage unit to store a part of overall weight pattern, where the partial weight storage unit includes a plurality of weight blocks, and each of the weight blocks stores a block part of the partial weight pattern in order of bits, wherein a cell array structure of the weight storage unit, with respect to a corresponding one of the data sets, is configured to perform a convolution operation on the data subset with each block part respectively to obtain a plurality of sequential weight operation values; step S106: using a block-wise output circuit that includes a plurality of shifters and a plurality of adders to sum up the plurality of weight operation values through a multistage shifting and adding operation, so as to obtain a weight output value expected from a direct convolution operation performed on the data subset with the partial weight pattern; and step S108: using a summation output circuit that includes a plurality of shifters and a plurality of adders to sum up the plurality of weight output values through a multistage shifting and adding operation, so as to obtain a sum value expected from a direct convolution operation performed on the input data set with the overall weight pattern.

Based on the foregoing, in the embodiment of the invention, the weight data of the memory unit is split and subjected to a convolution operation performed by a plurality of processing tiles. In addition, the memory unit of each processing tile is also split into a plurality of weight blocks to perform processing respectively. Thereafter, a final overall value may be obtained through a shifting and adding operation. Because a circuit of the processing tile is relatively small, an instruction cycle can be increased, and energy consumed (for example, heat generated) during the processing of the processing tile can be reduced.

Although the invention has been described with reference to the above embodiments, the embodiments are not intended to limit the invention. A person of ordinary skill in the art may make variations and improvements without departing from the spirit and scope of the invention. Therefore, the protection scope of the invention should be subject to the appended claims.

What is claimed is:

1. An artificial intelligence accelerator, configured to receive a binary input data set and a selected layer of a plurality of layers of an overall weight pattern to perform a convolution operation, wherein the input data set is divided into a plurality of data subsets, and the artificial intelligence accelerator comprises:
a plurality of processing tiles, wherein each of the processing tiles comprises:
a receive-end component, configured to receive one of the data subsets;
a weight storage unit, configured to store a part of the overall weight pattern, wherein the partial weight storage unit comprises a plurality of weight blocks, and each of the weight blocks stores a block part of the partial weight pattern in order of bits, wherein a cell array structure of the weight storage unit, with respect to a corresponding one of the data sets, configured to perform a convolution operation on the data subset with each block part respectively to obtain a plurality of sequential weight operation values; and
a block-wise output circuit, comprising a plurality of shifters and a plurality of adders, and configured to sum up the plurality of weight operation values through a multistage shifting and adding operation, so as to obtain a weight output value expected from a direct convolution operation performed on the data subset with the partial weight pattern; and
a summation output circuit, comprising a plurality of shifters and a plurality of adders, and configured to sum up the plurality of weight output values through a multistage shifting and adding operation, so as to obtain a sum value expected from a direct convolution operation performed on the input data set with the overall weight pattern.

2. The artificial intelligence accelerator according to claim 1, wherein the input data set comprises i bits, and is divided into p data subsets, i and p are integers, and each of the data subsets comprises i/p bits.

3. The artificial intelligence accelerator according to claim 1, wherein the input data set comprises i bits, and the quantity of the plurality of processing tiles is p, the input data set is divided into p data subsets, i and p are integers greater than or equal to 2, i is greater than p, and each of the data subsets comprises i/p bits.

4. The artificial intelligence accelerator according to claim 3, wherein the quantity of the plurality of weight blocks comprised in the partial weight storage unit is q, q is an integer greater than or equal to 2, the partial weight storage unit comprises j bits, j and q are integers greater than or equal to 2, j is greater than q, and each of the weight blocks comprises j/q memory cells.

5. The artificial intelligence accelerator according to claim 4, wherein the block-wise output circuit comprises at least one shifter and at least one adder in each stage of the shifting and adding operation; and
two adjacent input values of a plurality of input values in each stage are one processing unit, after passing through the shifter, one input value in a higher bit location is added by the adder to the other input value in a lower bit location, and is output to a next stage, and in a last stage, a single value is output and used as the weight output value corresponding to the processing tile.

6. The artificial intelligence accelerator according to claim 5, wherein a shift amount of the shifter in a first stage is j/q memory cells, and a shift amount of the shifter in a next stage is twice that of the shifter in a previous stage.

7. The artificial intelligence accelerator according to claim 4, wherein the summation output circuit comprises at least one shifter and at least one adder in each stage of the shifting and adding operation; and
two adjacent input values of a plurality of input values in each stage are one processing unit, after passing through the shifter, one input value in a higher bit location is added by the adder to the other input value in a lower bit location, and is output to a next stage, and in a last stage, a single value is output and used as the sum value.

8. The artificial intelligence accelerator according to claim 7, wherein a shift amount of the shifter in a first stage is i/p bits, and a shift amount of the shifter in a next stage is twice that of the shifter in a previous stage.

9. The artificial intelligence accelerator according to claim 1, further comprising:
a normalization processing circuit, configured to normalize the sum value to obtain a normalization sum value; and
a quantization processing circuit, configured to quantize the normalization sum value into an integer value by using a base number.

10. The artificial intelligence accelerator according to claim 1, wherein the processing circuit comprises a plurality of sense amplifiers, respectively configured to sense each block part to perform a convolution operation to obtain a plurality of sensed values as the plurality of weight operation values.

11. A processing method applied to an artificial intelligence accelerator, wherein the artificial intelligence accelerator receives a binary input data set and a selected layer of a plurality of layers of an overall weight pattern to perform a convolution operation, and the input data set is divided into a plurality of data subsets, and the processing method comprises:
using a plurality of processing tiles, and each of the processing tiles comprises operations of:
using a receive-end component to receive one of the data subsets;
using a weight storage unit to store a part of the overall weight pattern, wherein the partial weight storage unit comprises a plurality of weight blocks, and each of the weight blocks stores a block part of the partial weight pattern in order of bits, wherein a cell array structure of the weight storage unit, with respect to a corresponding one of the data sets, is configured
to perform a convolution operation on the data subset with each block part respectively to obtain a plurality of sequential weight operation values;
using a block-wise output circuit that comprises a plurality of shifters and a plurality of adders to sum up the plurality of weight operation values through a multistage shifting and adding operation, so as to obtain a weight output value expected from a direct convolution operation performed on the data subset with the partial weight pattern; and
using a summation output circuit that comprises a plurality of shifters and a plurality of adders to sum up the plurality of weight output values through a multistage shifting and adding operation, so as to obtain a sum value expected from a direct convolution operation performed on the input data set with the overall weight pattern.

12. The processing method of the artificial intelligence accelerator according to claim 11, wherein the input data set comprises i bits, and is divided into p data subsets, i and p are integers, and each of the data subsets comprises i/p bits.

13. The processing method of the artificial intelligence accelerator according to claim 11, wherein the input data set comprises i bits, and the quantity of the plurality of processing tiles is p, the input data set is divided into p data subsets, i and p are integers greater than or equal to 2, i is greater than p, and each of the data subsets comprises i/p bits.

14. The processing method of the artificial intelligence accelerator according to claim 13, wherein the quantity of the plurality of weight blocks comprised in the partial weight storage unit is q, q is an integer greater than or equal to 2, the partial storage memory unit comprises j bits, j and q are integers greater than or equal to 2, j is greater than q, and each of the weight blocks comprises j/q memory cells.

15. The processing method of the artificial intelligence accelerator according to claim 14, wherein each stage of the shifting and adding operation performed by the block-wise output circuit comprises using at least one shifter and at least one adder; and
two adjacent input values of a plurality of input values in each stage are one processing unit, after passing through the shifter, one input value in a higher bit location is added by the adder to the other input value in a lower bit location, and is output to a next stage, and in a last stage, a single value is output and used as the weight output value corresponding to the processing tile.

16. The processing method of the artificial intelligence accelerator according to claim 15, wherein a shift amount of the shifter in a first stage is j/q memory cells, and a shift amount of the shifter in a next stage is twice that of the shifter in a previous stage.

17. The processing method of the artificial intelligence accelerator according to claim 14, wherein each stage of the shifting and adding operation performed by the summation output circuit comprises using at least one shifter and at least one adder; and
two adjacent input values of a plurality of input values in each stage are one processing unit, after passing through the shifter, one input value in a higher bit location is added by the adder to the other input value in a lower bit location, and is output to a next stage, and in a last stage, a single value is output and used as the sum value.

18. The processing method of the artificial intelligence accelerator according to claim 17, wherein a shift amount of the shifter in a first stage is i/p bits, and a shift amount of the shifter in a next stage is twice that of the shifter in a previous stage.

19. The processing method of the artificial intelligence accelerator according to claim 11, further comprising:
using a normalization processing circuit to normalize the sum value to obtain a normalization sum value; and
using a quantization processing circuit to quantize the normalization sum value into an integer value by using a base number.

20. The processing method of the artificial intelligence accelerator according to claim 11, wherein the processing circuit comprises a plurality of sense amplifiers, respectively configured to sense each block part to perform a convolution operation to obtain a plurality of sensed values as the plurality of weight operation values.
